(19) United States
(12) Patent Application Publication
(10) Pub. No.: US 2007/0240493 A1
(43) Pub. Date: Oct. 18, 2007

(54) Sprayer-sniffer probe

(76) Inventors: Shane Conlan, Santa Barbara, CA (US); Dennis Ebejer, Los Olivos, CA (US)

Correspondence Address: Kenneth L. Stein, 1080 Via Regina, Santa Barbara, CA, 93111, US

(21) Appl. No.: 11/406,801

(22) Filed: Apr. 18, 2006

(51) Int. Cl. G01M 3/04; G01D 21/00

(52) U.S. Cl. 73/40.7; 73/866.5

(57) ABSTRACT

A selectively configurable sniffer-sprayer device. The sniffer-sprayer device may be configured to regularly emit a tracer gas at a predetermined concentration. Alternatively, the sniffer-sprayer device may be selectively configured to regularly draw gas proximate an end thereof and transport said gas to a sensing device. The sniffer-sprayer device may be configured to cooperatively function with a variety of existing tracer gas detection systems.

### BACKGROUND OF THE INVENTION

1. Field of the Invention

The present invention relates generally to systems for detecting leaks within fluid containing systems. More particularly, the invention relates to a gas detection and delivery devices employed in testing the integrity of the seals for fluid containing apparatus.

2. Description of Related Art

Known leak-testing systems include a component that is disposed at either an interior region or an exterior region of a part under test. With the application of a gas, usually helium, or hydrogen, the aforementioned region is placed at a higher pressure than the other of the interior region or exterior region of the part under test. As such, if a leak is present in the part under test, the gas will flow from the higher-pressure side of the part under test to the lower-pressure side of the part under test.

Such known leak detection systems and associated methods employ a mass spectrometry based apparatus to test for the presence of a tracer gas at the lower pressure side of the part under test. The tracer gas having been introduced on the higher-pressure side of the part under test and thereafter having migrated to the lower-pressure side of the part.

Leak detection systems that generate a higher pressure internal to a tested part, employ a tracer gas detection apparatus disposed external the part and not in direct fluid communication with the part. As depicted in FIG. 1, a tracer gas detection apparatus is configured to detect the presence and concentration of tracer gas that migrates external the tested part. The tracer gas detection apparatus may include a sniffer device 7 which is brought into abutment with the external surface of the tested part 1. Gas is drawn into the sniffer device 7 and channeled into a gas detection apparatus 4, and past a detector to detect the presence of tracer gas. One method of drawing the gas proximate to the probe is with a fan unit that draws gas into the probe and eventually channels the gas to the detector. Note that reference numeral 5 denotes an evacuating pump for the detector 4, and reference numeral 6 denotes a controller for controlling valves and for gathering data.

As shown in FIG. 2, known leak detection systems that generate a higher pressure external to a tested part, employ a sprayer device 10 disposed external the part 1. The sprayer device 10 is configured for attachment to a pressurized tracer gas source 8 and is configured to regularly expel a selected concentration of a tracer gas. Mass spectrometry may then be employed to measure the concentration of the tracer gas that migrates internal the tested part 1. A tracer gas detector 4′, such as a helium leak detector, is brought into fluid communication with the interior of the tested part 1. An evacuating pump 5′, located downstream of the tracer gas detector 4′ draws gas into and through the detector 4′. Controller 6′ controls the opening and closing of valves and gathers data.

While such systems and methods are known, sniffer devices and sprayer devices have been designed for use with specific gas detection apparatus. Additionally, there is no known device that is configuratively operable both as a sprayer and a sniffer device.

Therefore, what is needed in the art is a combination sniffer-sprayer device. Additionally, what is needed in the art is a combination sniffer-sprayer device that may be configured to function with a variety of existing tracer gas detection systems.

### SUMMARY OF THE INVENTION

It is to the solution of the hereinabove mentioned problems to which the present invention is directed. In accordance with the present invention there is provided a combination sniffer-sprayer device comprising:

a fluid conduit having a first end, a second end and defining a longitudinal axis extending from said first end to said second end, the fluid conduit defining an aperture extending from said first end to said second end providing for fluid flow therethrough;

a configurable passage disposed interior the fluid conduit, said configurable passage having a longitudinal axis and defining a channel having a cross-sectional area passing therethrough coaxial with said longitudinal axis, said longitudinal axis of said configurable passage substantially coaxial with said longitudinal axis of said fluid conduit and in fluid communication therewith, said passage configurable to vary the cross-sectional area of said channel defined thereby.

It is an object of the present invention to provide a device that is configuratively operable as sniffer device and a sprayer device.

It is additionally an object of the present invention to provide a sprayer device that may be configured to function with a variety of existing tracer gas detection systems.

It is further an object of the present invention to provide a device that is configuratively operable as sniffer device and a sprayer device and when said device is configured for operation as a sniffer device it may additionally be configured to interoperate with a variety of existing tracer gas detection systems.

The present invention is uniquely configurable to operate either to spray a minimum amount of a selected trace-gas, or to draw in gas via a preselected pressure-drop. The pressure drop across the device according to the present invention is selectable by a user such that the pressure drop may be substantially equivalent with a required pressure for an interoperable trace-gas detection system.

A sniffer-sprayer device according to the present invention comprises a fluid conduit having a first end and a second end. The device defines a longitudinal axis that extends from the first end to the second end. The fluid conduit defines an aperture extending from said first end to said second end and which provides for fluid flow therethrough;

A configurable passage is disposed interior the fluid conduit. The configurable passage has a cross-sectional area that is configurable by a user. By matching the pressure at the downstream side of the configurable passage to the input pressure required by a selected trace-gas detection system, the device according to the present invention may be configured to operate with a variety of such trace-gas detection systems.

An on/off valve is disposed interior the conduit to enable or preclude fluid flow therethrough. In operation and when in the ‘off’ position, the valve precludes flow of a trace-gas when the device is in fluid communication with a pressurized trace-gas source. When position in the ‘on’ position, the valve provides for trace-gas flow through the sprayer-sniffer device.

For a more complete understanding of the present invention, reference is made to the following detailed description and accompanying drawings. In the drawings, like reference characters refer to like parts, in which:

### BRIEF DESCRIPTION OF THE DRAWINGS

FIG. 1 depicts a prior art leak inspection system including an external trace-gas sniffer;

FIG. 2 depicts a prior art leak inspection system including an external trace-gas sprayer;

FIG. 3 is a schematic of a trace-gas sniffer-sprayer device in accordance with the present invention;

FIG. 4 is a schematic of a trace-gas sniffer-sprayer device operably connected to a trace gas detector and configured for operation as a sniffer device; and

FIG. 5 is a schematic of a trace-gas sniffer-sprayer device operably connected to a pressurized trace-gas source and configured for operation as a sprayer device.

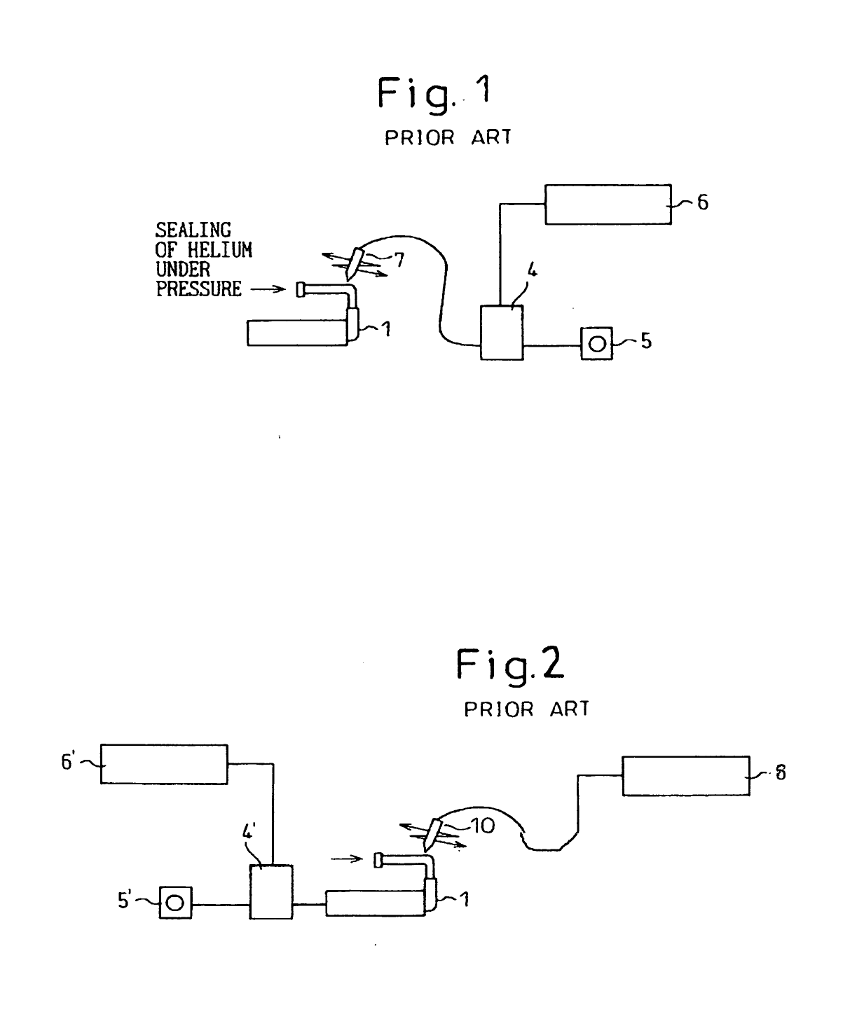

### DESCRIPTION OF THE PREFERRED EMBODIMENTS

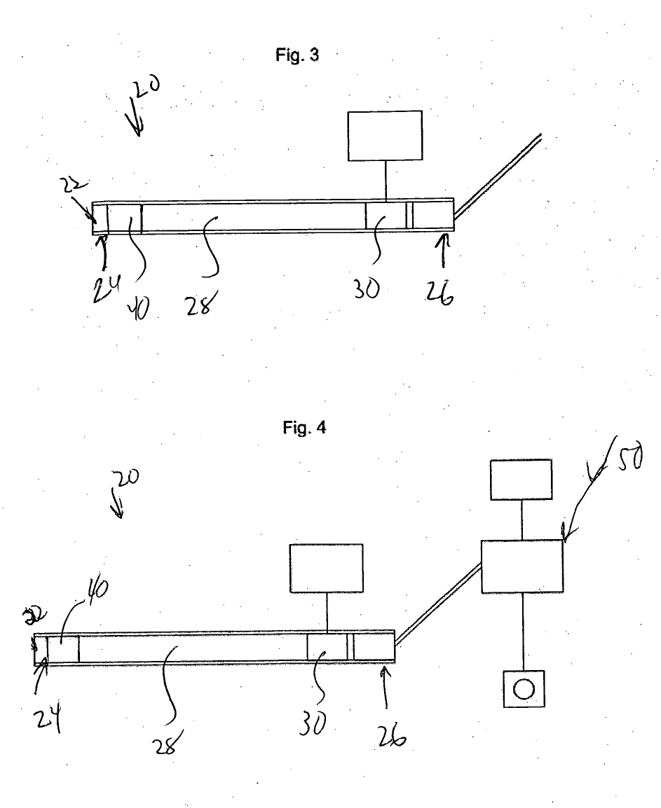

Referring to the drawings more particularly by reference numbers, FIG. 3 shows sniffer-sprayer device 20 according to the present invention. The device 20 is uniquely configurable to operate both in a sniff mode and in a spray mode, as described hereinbelow.

The sniffer-sprayer device 20 includes a fluid conduit 22 having a first end 24 and a second end 26. The fluid conduit 22 is preferably cylindrical in configuration and is formed from materials known to those skilled in the relevant art. The fluid conduit 22 has a longitudinal axis x extending from said first end 24 to said second end 26, the fluid conduit 22 defining an aperture 28 extending from said first end 24 to said second end 26 which provides for fluid flow therethrough.

A configurable passage 30 having a variable cross-sectional area is disposed interior the fluid conduit 22 and is in fluid communication therewith. The configurable passage 30 has a longitudinal axis substantially coaxial with the longitudinal axis x of the fluid conduit 22. The configurable passage 30 is selectively varied by a user using a dial or some other known variable selector. The configurable passage is preferably a throttle valve such as a micrometering valve produced by surgelock. In practive, a 0.1° microtapered provides for 0.01 cuft/min to 0.2 cuft/min flowrates.

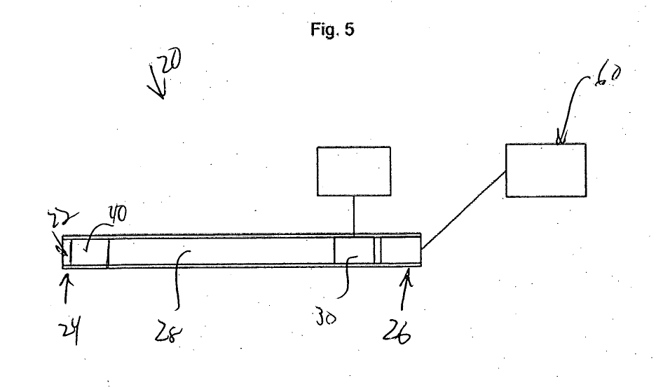

As shown in FIGS. 4 & 5, an on/off valve 40 is disposed interior the conduit 22 to enable or preclude fluid flow therethrough. In operation and when in the ‘off’ position, the valve 40 precludes flow of a trace-gas when the device is in fluid communication with a trace-gas detection system 50, or alternatively and as depicted in FIG. 5, a pressurized trace-gas source 60. When position in the ‘on’ position, the valve 40 provides for trace-gas flow through the sprayer-sniffer device 20 either from the pressurized trace-gas source 60, or the trace-gas detection system 50 when connected thereto.

The device 20 is connectable to a pressurized trace-gas source, such as helium or hydrogen and such connection means are well-known to those skilled in the art. Additionally, the device according to the present invention is connectable to trace-gas detection systems via well-known connection means and as such shall not be discussed further hereinbelow.

In operation with a trace-gas detector 50, the sniffer-sprayer device 20 is attached to the trace-gas detector 50 via well-known connection means. The configurable passage 30, which is again preferably a throttle vale, is set to a preselcted value, said preselcted value defined as the required inlet pressure for said tracer gas detector 50. The on/off valve is then opened allowing trace-gas to flow through the device 20 and into the trace-gas detection system 50.

In operation with a trace-gas source 60, the sniffer-sprayer device 20 is attached to the trace-gas source 60 via well-known connection means. The configurable passage 30, which is again preferably a throttle vale, is set to a preselected value and the on/off valve is then opened allowing trace-gas to flow through the device 20 from the pressurized trace-gas source 60 and out an opposed end of the device 20.

While certain exemplary embodiments of the present invention have been described and shown on the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. As such, what is claimed is:

1. A sniffer-sprayer device comprising:
a fluid conduit having a first end, a second end and defining a longitudinal axis extending from said first end to said second end, the fluid conduit defining an aperture extending from said first end to said second end providing for fluid flow therethrough;
a configurable passage disposed interior the fluid conduit, said configurable passage having a first end, a second end, and a longitudinal axis and defining a channel having a cross-sectional area passing therethrough coaxial with said longitudinal axis, said longitudinal axis of said configurable passage substantially coaxial with said longitudinal axis of said fluid conduit and in fluid communication therewith, said passage configurable to vary the cross-sectional area of said channel defined thereby.

2. The sniffer-sprayer device of claim 1, wherein said sniffer-sprayer device further comprises a valve for precluding fluid flow therethrough.

3. The sniffer-sprayer device of claim 2, wherein said valve for precluding fluid flow therethrough is disposed proximate the first end of the configurable passage in fluid communication with the channel defined by said configurable passage.

4. The sniffer-sprayer device of claim 2, wherein said device is configured to provide for flow rate of at most 0.2 cuft/min.

5. The sniffer-sprayer device of claim 1, wherein said sniffer-sprayer device is in fluid communication with a pressurized trace-gas source.

7. The sniffer-sprayer device of claim 1, wherein said sniffer-sprayer device is in fluid communication with a trace-gas detection system.

8. A method for configuring a sniffer-sprayer device for use with a trace-gas detector, comprising the steps of:
a. attaching the probe to the tracer gas detector;
b. adjusting a throttle vale disposed the probe to a preselected value, said preselected value defined as the required inlet pressure for said tracer gas detector; and
c. opening a valve disposed the sniffer-sprayer probe for enabling fluid flow therethrough.

9. A method for configuring a sniffer-sprayer device for use with a pressurized trace-gas source, comprising the steps of:
a. attaching the sprayer-sniffer device to the trace-gas source;
b. adjusting a throttle vale disposed the probe to a preselected value; and
c. opening a valve disposed the sniffer-sprayer probe for enabling fluid flow therethrough.
